(19) United States
(12) Patent Application Publication
(10) Pub. No.: US 2008/0235795 A1
(43) Pub. Date: Sep. 25, 2008

(54) System and Method for Confirming Digital Content

(76) Inventors: Mark M. Ishikawa, Los Gatos, CA (US); Leland Woo, South San Francisco, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/052,967

(22) Filed: Mar. 21, 2008

Related U.S. Application Data
(60) Provisional application No. 60/896,585, filed on Mar. 23, 2007.

(51) Int. Cl. G06F 21/00

(52) U.S. Cl. 726/22

(57) ABSTRACT

A system for confirming digital content and methods for making and using same. The system and methods comprise determining how to search for a file. The system and methods comprise searching for a file and selectively obtaining a file. Further, they comprise verifying a file, and subsequently categorizing the file. A file that is verified can be known as such, thereby preventing the file to be re-verified. The file can be stored along with information about the file. The file and its information can be sent to a data reporting system or interface. An advantageous aspect of the present invention is the ability to perform semi-autonomously.

### CROSS REFERENCE TO RELATED APPLICATIONS

This application claims priority to a U.S. provisional patent application Ser. No. 60/896,585, filed Mar. 23, 2007. Priority to the provisional application is expressly claimed, and the disclosure of the provisional application is hereby incorporated herein by reference in its entirety.

### BACKGROUND

With the advent of the internet, people have been able to share many different types of information with each other with increased ease. Unfortunately, some use the internet as a tool for sharing information or data that is not owned by them. Intellectual property right misappropriation, including copyright infringement, via the internet has become a major hurdle in the overall protection of intellectual property rights throughout the world. To protect their rights effectively, intellectual property right holders should be able to efficiently and accurately detect infringement of their intellectual property that occurs via the internet or the World Wide Web (“WWW”).

One popular and common method for detecting infringement is illustrated in FIG. 1. The prior art provides for the simple steps of gathering the potentially infringing data (as in 100), verifying it based on matching filenames, file size ranges, meta data, and/or file formats (as in 101) to the actual title, size, or file formats of the copyrighted material, and accepting or rejecting the data as an infringement of rights based on this matching (as in 102). This followed the previous “good faith belief” file verification thresholds (as defined by the Digital Millennium Copyright Act).

Based on this method, potentially misnamed files were reported as intellectual right misappropriation. Moreover, some files that are infringing upon one's copyrights could slip through undetected. This lower threshold can lower the validity of copyright violation claims and weaken litigation cases. Further, public (which includes potential customers) perception of companies who own the rights to copyrights is negatively influenced when the companies actively seek to protect those rights against non-infringers.

As should be apparent, there is a long-felt and unfulfilled need for a way to better verify whether files truly do infringe one's copyrights. With the increase of confidence based on verified files, Internet Service Providers (“ISP” or “ISPs”) will be more likely to forward notices to users and any follow-up litigation cased for repeat copyright infringers will be stronger. There is a need for a higher level of confidence of file identification which increases the validity of reporting and potentially improves the results of a positive litigation outcome. The systems and methods disclosed serve to, among other things, serve these needs.

### DESCRIPTION OF DRAWINGS

The accompanying drawings, which are included as part of the present specification, illustrate the presently preferred embodiments and together with the general description given above and the detailed description of the preferred embodiments given below serve to explain and teach the principles of the disclosed embodiments.

FIG. 1 is a top-level flow chart illustrating the prior art.

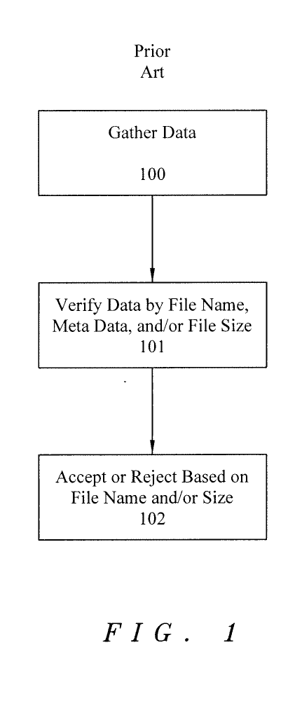

FIG. 2 is a top-level flow chart illustrating an exemplary embodiment of a method for confirming digital content.

FIG. 3 is a top-level flow chart illustrating an alternative embodiment of the method of FIG. 2, wherein search media distribution systems includes initial setup of a crawler, crawling, and collecting of the results from the crawler, and wherein determining to take action includes enabling the use of a data reporting system.

FIG. 4 is a flow chart illustrating an alternative embodiment of a method for confirming digital content.

FIG. 5 is a screenshot illustrating one manner by which the crawler of FIG. 3 can be enabled.

FIG. 6 is a screenshot illustrating one manner by which the crawler of FIG. 3 can display the resulting crawler-data collection.

FIG. 7 is an illustration of an exemplary computer architecture for use with the present system, according to one embodiment.

It should be noted that the figures are not drawn to scale and that elements of similar structures or functions are generally represented by like reference numerals for illustrative purposes throughout the figures. It also should be noted that the figures are only intended to facilitate the description of the preferred embodiments of the present disclosure. The figures do not illustrate every aspect of the disclosed embodiments and do not limit the scope of the disclosure.

### DETAILED DESCRIPTION

A system for confirming digital content and methods for making and using same.

In the following description, for purposes of explanation, specific nomenclature is set forth to provide a thorough understanding of the various inventive concepts disclosed herein. However it will be apparent to one skilled in the art that these specific details are not required in order to practice the various inventive concepts disclosed herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission, or display devices.

The disclosed embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk, including floppy disks, optical disks, CD-ROMS, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the disclosed embodiments are not described with reference to any particular programming language. It will be appreciated that a variety of programming languages may be used to implement the teachings of the disclosed embodiments.

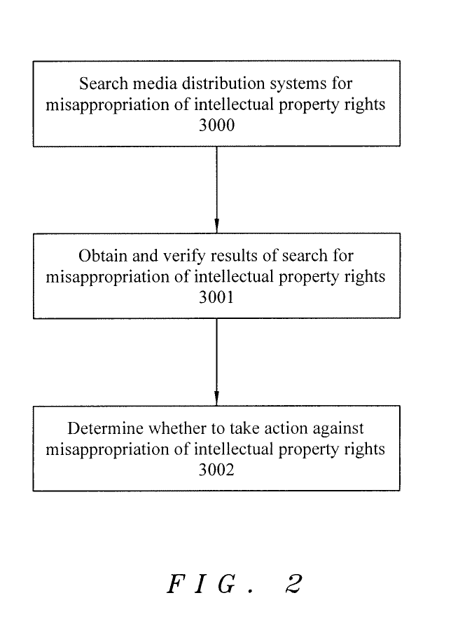

FIG. 2 is a top-level flow chart illustrating an exemplary embodiment of a method for confirming digital content. In the present embodiment, the method would entail first searching media distribution systems for misappropriation of intellectual property 3000. Next the embodiment of the method would obtain and verify the results of the search 3000 for misappropriation of intellectual property rights 3001. This would be followed by a determination of whether to take action against the misappropriation of intellectual property rights 3002.

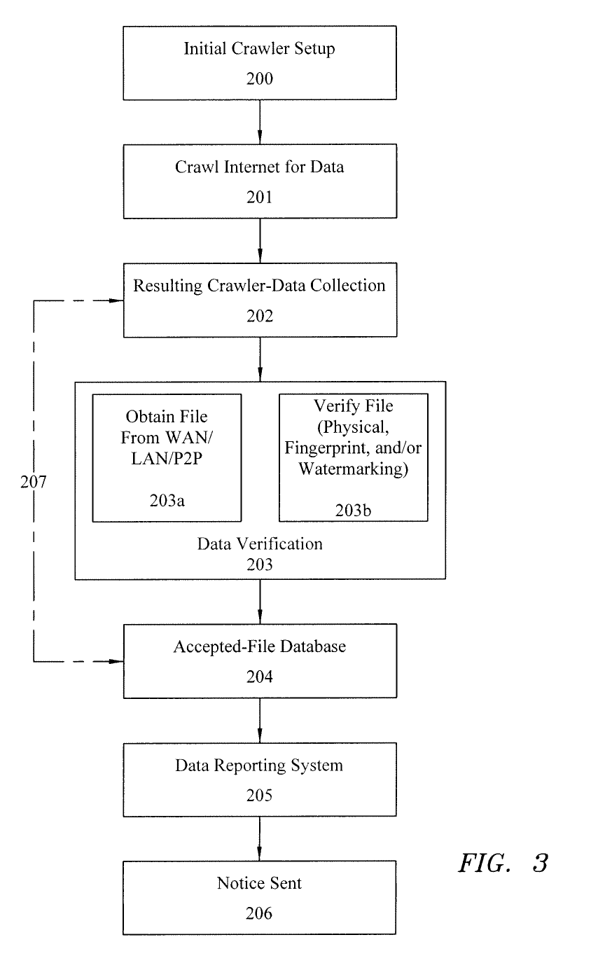

FIG. 3 is a top-level flow chart illustrating an alternative embodiment of the method of FIG. 2, wherein search media distribution systems includes initial setup of a crawler, crawling, and collecting of the results from the crawler, and wherein determining to take action includes enabling the use of a data reporting system. Initially a decision as to what information to be searched for will be determined. For example, the information searched for could be useful to find misappropriation of intellectual property rights such as misuse of intellectual property or infringement of an intellectual property right. This decision could be based on any information which would be useful in finding misappropriation of intellectual property right material or data on the internet that has some connection, affiliation, or otherwise association with an intellectual property. For example, if searching for infringing data on the internet for a copyrighted movie, the title of the movie, name of the director, name of the actors, or any other data that would be associated with the movie would be useful. Once determined or collected, this information could then be utilized to crawl through the internet, internet protocols, websites, or other media distribution systems with the intention of using the information to locate potential misappropriation of intellectual property rights.

To crawl, or search, the internet for material or data that misappropriates an intellectual property right, one could conduct the crawl or search by human input and action. For example, one could determine the information to use (as explained above) and then crawl or search the internet using search engines such as ones provided by Yahoo, Google, or Microsoft. A human could also search Peer-to-Peer sites and any other online media or data distribution systems. A more efficient way to conduct the crawl or search would be a semi-autonomous method by utilizing a computer to search or crawl the internet, internet protocols, websites, local area networks, wide area networks, or other media distribution systems (hereinafter “distribution sites”). It should be apparent to one skilled in the art that “utilize a computer” also encompasses the usage of multiple computers to conduct the task at hand. The multiple computers may have the capability to communicate via a network. In one embodiment, the usage of multiple computers will be determined based on the task at hand.

To utilize a computer to do so, according to one embodiment, one would first perform 200: initial crawler setup. In 200, one could input the information determined or collected that has some connection, affiliation, meta-data from a copyrighted work, or otherwise associated with the copyrighted work (hereinafter “keyword”) into a search field. In one embodiment, there would be a capability to input more than one keyword. In another one embodiment, there would be a capability to enter keyword or keywords such that they would all be searched for during the same search. In another embodiment, there would be a capability to place restrictions on the search of the keyword. For example, one would be able to search for keyword “Star Wars” but restrict the returns to not include “Return of the Jedi” (which is a movie title for the Star Wars movie series). In an alternative embodiment, there would be a procedure for selecting which distribution sites to search for the keyword or keywords that were inputted into the search field or fields.

The crawl or crawling operation set forth above can comprise any conventional type of crawling operation, such as in the manner set forth in the co-pending United States patent applications, entitled “Identification and Tracking of Digital Content Distributors on Wide Area Networks,” Ser. No. 10/845,436, filed on May 12, 2004 which is assigned to the assignee of the present application and the respective disclosures of which are hereby incorporated herein by reference in its entirety.

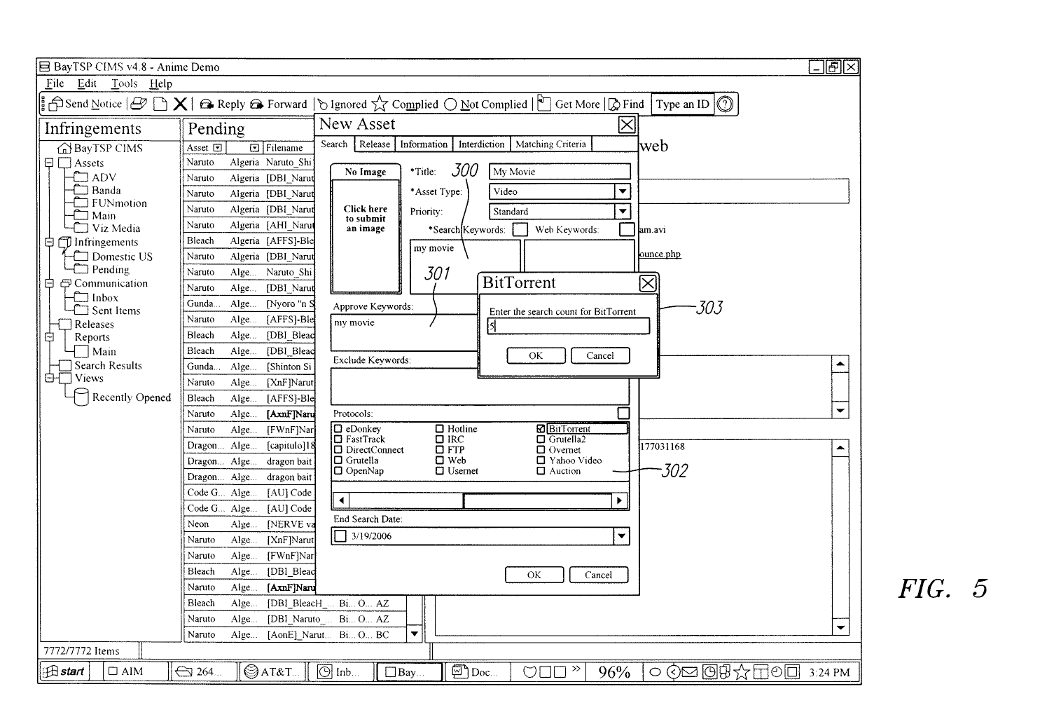

As an example, FIG. 5 is a sample screenshot from a potential software application that enables initial crawler setup according to one embodiment. In FIG. 5, object 300 symbolizes the location to input the keyword or keywords for search. According to one embodiment, once inputted into 300, 301 would then save the keyword or keywords. Other keyword or keywords could be inputted into 300. As they are entered, the keywords are stored in 301 for later crawling or searching. The initial crawler setup in FIG. 5 also allows the user to select which distribution sites to search. According to another embodiment, object 302 lists the available options for the user to which the user would select by clicking on the box next to the distribution site. Optionally, the user may also be queried for the number of times to search within all or individual distribution sites as represented by object 303. For example, the user may enter the number of times to search per day, per week, per month, or per year.

After the keyword or keywords have been selected and initial crawler setup 200 has been completed (if doing so utilizing a computer in the semi-autonomous method), then the disclosed embodiment is prepared for 201: crawling or searching for data. 201 requires the searching or crawling of the distribution sites as determined in 200 for the keyword or keywords chosen. The results of 201 are then gathered and optionally saved in 202: resulting crawler-data collection. This data that is collected contains the results of where the keywords were found. In one embodiment, the results also include additional information about each of the results found. Such additional information about each result includes, but is not limited to: time stamp of infringement, file name, file size, IP address, file hash or unique digital identifier, username, percentage of file offered by user, and/or protocol that the user is on.

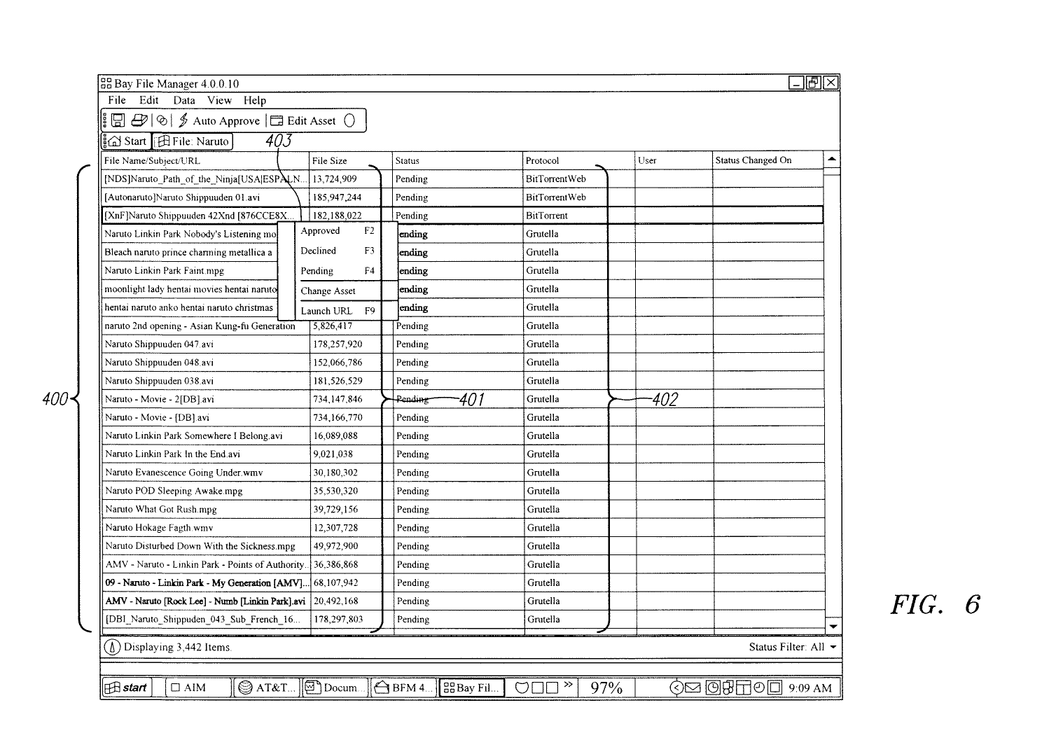

FIG. 6 is a sample screenshot from a potential software application that enables a listing of results from the searching or crawling of the internet for data 201, according to one embodiment. As illustrated in FIG. 6, a list of results for the occurrences of the keyword or keywords is displayed within 400. One type of information for each result that could be included is the file size of the result located as displayed within 401. Another type of information for each result that could be included is the distribution site (or protocol) that the result was found in as displayed within 402. As should be evident, there are many different types of information that can be gathered for the results found by 201 along with many different ways to organize the information for each result. FIG. 6 is provided only as an example according to one embodiment of 202. The information necessary for each result may also differ based on need or preference.

Based on the distribution site or protocol searched or crawled, more information may be collected in 202 as well. For example, the Peer to Peer (hereinafter “P2P”) file distribution protocols allow for wide distribution of large amounts of data over the internet. These protocols greatly speed up the distribution of data. It enables users to obtain portions of data from many different computers sharing (hereinafter “sharers”) that file or data instead of a single computer sharing that file or data. A P2P network can find many different sharers who have a copy or portions of a copy of a certain data on shared directories, and enables a single user to download different portions of the data from more than one sharer simultaneously. In some cases, the instant the user obtains even the first few pieces of data from one or more sharer, that user would also be making those few pieces available to anyone else seeking the same data. A P2P distribution protocol generally will automatically assign a unique “hash identifier” or “file hash” (hereinafter “hash”) to each file or data, which is how that file or data and portions of it are identified within the network. The probability of two files having the same hash is more than one billion to one. Thus, infringing files shared on a P2P protocol can be identified through both the unique hash assigned to each file or data, and by reference to the file or data name and file or data size.

A “hash identifier” or “file hash” can also be created utilizing different meta-data categories rather than just the contents of a file. These meta-data categories can comprise information such as the filename, file-size, file-type, keywords or any more information when available. The combination of various meta-data can be used to create a single unique identifier (hash identifier or file hash) that can be used to represent a given file throughout the system.

An IP address is a unique numerical identifier that is automatically assigned to a user by its Internet Service Provider (“ISP”) each time a user connects to the network. ISPs are each assigned certain ranges of IP addresses. ISPs typically keep track of the IP addresses assigned to their subscribers at any given moment and retain “user logs” for a limited period of time. Thus, in addition to the data or file name and data or file size of the data or file itself, other publicly available information from the network user utilizing the P2P protocol can be gathered. For example, the hash assigned to the data or file, how many IP addresses are sharing the same file or data, the time and date at which the user was found to have been offering the file for upload onto the network, the IP address assigned to the computer at the time of infringement, the percentage of the file the user is offering (if available) on the user's computer, and other public information can be gathered in 202. It should be evident to one skilled in the art that the amount of information that is gathered in by 202 can be varied and does not need to include every example listed above. Further, it should be evident to one skilled in the art that the examples of the type of information that can be gathered are not exhaustive. Lastly, it should be evident to one skilled in the art that the information gathered per result can be done at later parts of the disclosed embodiments.

The present embodiment needs to determine whether each of the results found are indeed what is searched for. For example, one could be searching for misappropriation of intellectual property rights. To do so, the results or data gathered is verified in 203. In one embodiment, the data verification could be conducted in a two step process. First the data or results of the possible infringing files need to be obtained as in 203a. The potentially infringing files may be obtained via a wide area network, local area network, a P2P network, or any other network in which the potentially infringing file can be found. It will be apparent to one skilled in the art that the obtaining of the file or data represented by the results can occur in numerous different times, each falling within the scope of the disclosed embodiments. Once obtained, the file needs to be verified as in 203b. The verification can be done in numerous ways, including using human input to determine whether the file is an infringing file (for example, if the file is a MPEG of a copyrighted movie, then the human could play the MPEG to determine whether it is truly a copy of the copyrighted movie), by utilizing a digital fingerprinting system for matching, or by utilizing a watermarking method. Generally, watermarking is a tag attached to content during the production phase which can later be used to identify the content. It can be represented as an audio, visual, and/or invisible digital mark to identify the content. In one embodiment, data verification 203 would filter out spoof or decoy files. Spoof or decoy files are provided on distribution sites with the intention to pollute or slow down users of these distribution sites from getting the real version of the sought after files or data. To filter out spoof or decoy files from being verified, one could obtain identification information from the creators of the spoof or decoy files. The obtaining of identification information can comprise any type of obtaining operation, such as being provided through a predetermined file creation algorithm, or by delivery via electronic messaging (i.e. email, or XML communication).

Digital fingerprinting refers to a method to identify and match digital files based on digital properties, trends in the data, and/or physical properties. For example, image properties and trends can be based on color and relative positioning. For video, the properties and trends may be luminescence and/or color, and pixel positioning for every certain number of frames. For audio, the properties and trends may be the change in amplitude of the sound wave over time. When tracking those properties and trends, one might end up with a fingerprint that is smaller than if the entire file was copied. The use of digital fingerprints allows one to compare and match imperfect copies of the digital files that represent the same content. One advantageous aspect of utilizing digital fingerprinting is the ability to handle a large number of verifications. The fingerprint can be applied later to other data or files to see if they represent earlier fingerprinted content. The probability of a match can be based on proprietary algorithms used to create digital fingerprints.

The fingerprinting operation set forth above can comprise any conventional type of fingerprinting operation, such as in the manner set forth in the co-pending United States patent applications, entitled “Method, Apparatus, and System for Managing, Reviewing, Comparing and Detecting Data on a Wide Area Network,” Ser. No. 09/670,242, filed on Sep. 26, 2000; and entitled “Method and Apparatus for Detecting Email Fraud,” Ser. No. 11/096,554, filed on Apr. 1, 2005, which are assigned to the assignee of the present application and the respective disclosures of which are hereby incorporated herein by reference in their entireties.

The verification operation set forth above can comprise any conventional type of verification operation, such as in the manner set forth in the co-pending United States patent applications, entitled “Identification and Tracking of Digital Content Distributors on Wide Area Networks,” Ser. No. 10/845,436, filed on May 12, 2004 which is assigned to the assignee of the present application and the respective disclosures of which are hereby incorporated herein by reference in its entirety.

Once the data or files have been verified, it will be known which of the results are truly within the scope of the search (hereinafter “good results”). For example, once the results are verified, one would know which of the results are truly misappropriations of intellectual property rights. In one embodiment, once the data or files are verified as in 203, the good results would be marked or categorized as such. In another embodiment, the good results would be placed into a database (204: Accepted-Results Database). In an alternative embodiment, the database would also be capable of holding any or all information that has been collected for each good result. In another alternative embodiment, the database would be able to hold any or all information for each result (including not good results).

One advantageous aspect of the disclosed embodiments includes the ability to organize the results so as to utilize the results for future searches. For example, in one embodiment, the accepted-file database 204 would be able to communicate or be accessed by future searches as to help determine which results are likely or not likely good results. In the embodiment illustrated by FIG. 3, the communication would occur through 207, in which the database would communicate or be accessed during a future search by the resulting crawler-data collection 202. In another embodiment, the information which is communicated or accessed would be the hash identifier or file hash from a result already verified as a good or not good result. In the embodiment illustrated in FIG. 6, object 403 would allow for the selection of a result's status where the result's status could be changed from not-verified to verified without the result file or data having to be re-verified. For example, since the hash of a file or data is very unique, the comparison of good result's hash identifier or file hash to a file or data from a new search could help determine whether that file or data is a good result without having the result data verified (or re-verified) in 203.

In one embodiment, the database would send a list of good and not good results to a data reporting system 205. The data reporting system could provide a recipient of a notice, such as an ISP, the confidence that the infringement being reported was reviewed beyond the minimum standards. The data reporting system may allow for the processing of some or all of the information and/or data in the database such that decisions can be made whether to enforce intellectual property rights upon some misappropriation of such rights.

In one embodiment, a notice is sent to the appropriate party based on the good results. In another embodiment, the data reporting system would be utilized to send a notice 206 to the appropriate party. The data reporting system may be utilized to make decisions and transactions such as notice sending. The appropriate party would be determined by a party's connection to the good result. For example, the appropriate party could be the party that is responsible for the uploading of copyright infringing data or file. The notice could be a takedown notice.

In one embodiment, an interface would connect to database 204 which would allow for the management, viewing, or otherwise control the database. For example, the information from the database could be viewed by the interface. In one embodiment, the interface would allow for a customer or user of the disclosed embodiments to view, manage, enforce, or track the results. In an alternative embodiment, the interface would allow the customer or user of the disclosed embodiments to view the good results to determine whether to enforce their rights over the copyright.

In one embodiment, the interface would allow the customer or user to add, remove, or somehow edit the keyword or keywords during the initial crawler setup 200. In another embodiment, the interface would allow the customer or user to review the verification of all or certain results to determine whether to send a takedown notice or view the history of the result to determine if a takedown notice or notices have been sent, or to obtain any other information about the result or results. In an additional embodiment, the customer or user could create customized rules for the crawl internet for data 201. In an alternative embodiment, the customer or user could customize a report generator connected to the data reporting system 205. In another alternative embodiment, all capabilities or attributes mentioned above for the initial crawler setup 200 could be accomplished by the interface. In another embodiment, the interface would be associated with a data reporting system 205. Alternatively, the data reporting system would be comprised of the interface.

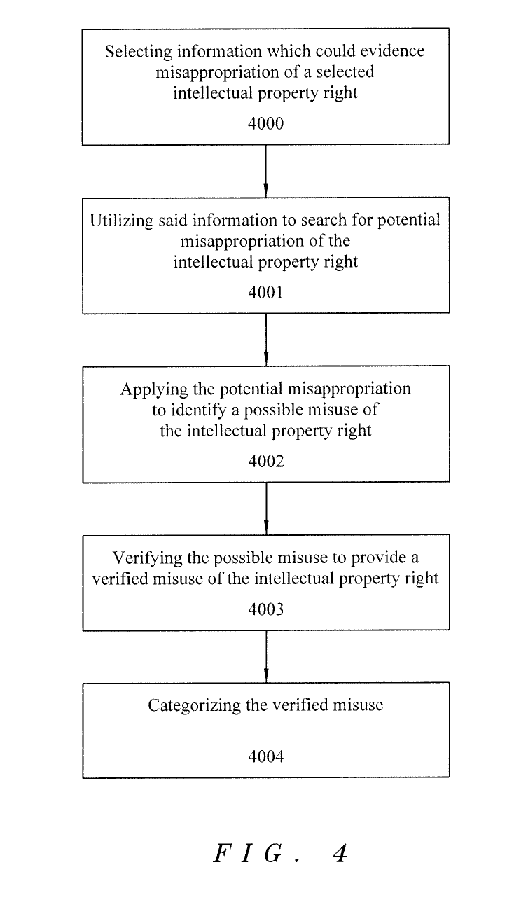

FIG. 4 is a flow chart illustrating an alternative embodiment of a method for confirming digital content. In the present embodiment, the method would comprise 4000 selecting information which could evidence misappropriation of a selected intellectual property right. The method would further comprise 4001 utilizing said information to search for potential misappropriation of the intellectual property right. Additionally, the method would 4002 apply the potential misappropriation to identify a possible misuse of the intellectual property right. Further, the method would comprise 4003 verifying the possible misuse to provide a verified misuse of the intellectual property right. In an alternative embodiment, the method would comprise 4004 categorizing the verified misuse.

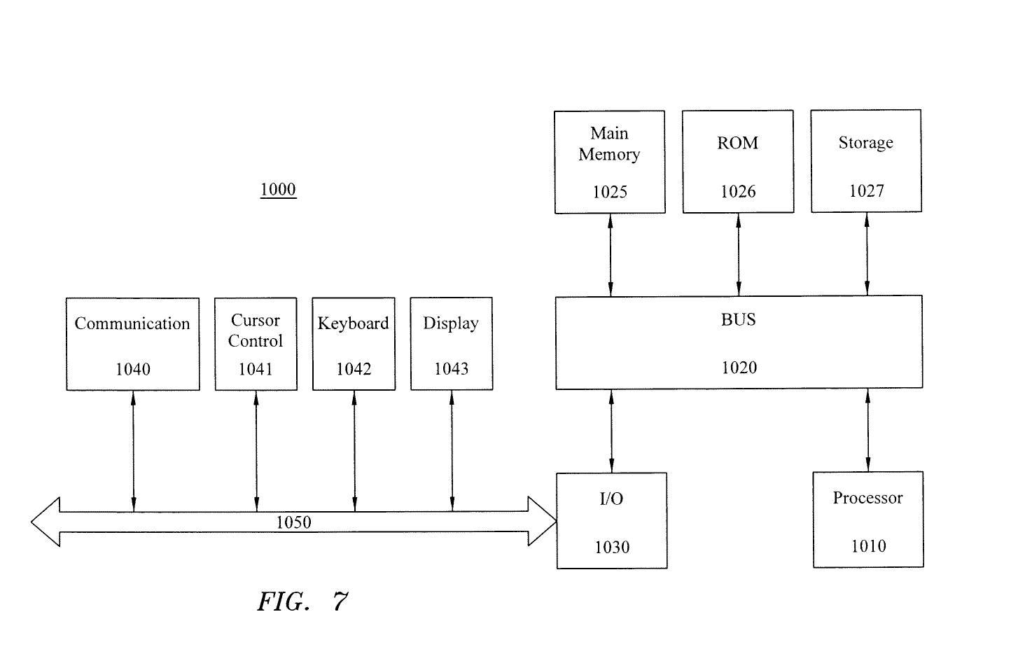

FIG. 7 is an illustration of an exemplary computer architecture for use with the present system, according to one embodiment. Computer architecture 1000 is used to implement the computer systems or data processing systems described in the various embodiments. One embodiment of architecture 1000 comprises a system bus 1020 for communicating information, and a processor 1010 coupled to bus 1020 for processing information. Architecture 1000 further comprises a random access memory (RAM) or other dynamic storage device 1025 (referred to herein as main memory), coupled to bus 1020 for storing information and instructions to be executed by processor 1010. Main memory 1025 is used to store temporary variables or other intermediate information during execution of instructions by processor 1010. Architecture 1000 includes a read only memory (ROM) and/or other static storage device 1026 coupled to bus 1020 for storing static information and instructions used by processor 1010.

A data storage device 1027 such as a magnetic disk or optical disk and its corresponding drive is coupled to computer system 1000 for storing information and instructions. Architecture 1000 is coupled to a second I/O bus 1050 via an I/O interface 1030. A plurality of I/O devices may be coupled to I/O bus 1050, including a display device 1043, an input device (e.g., an alphanumeric input device 1042 and/or a cursor control device 1041).

The communication device 1040 is for accessing other computers (servers or clients) via a network. The communication device 1040 may comprise a modem, a network interface card, a wireless network interface, or other well known interface device, such as those used for coupling to Ethernet, token ring, or other types of networks.

The disclosure is susceptible to various modifications and alternative forms, and specific examples thereof have been shown by way of example in the drawings and are herein described in detail. It should be understood, however, that the disclosure is not to be limited to the particular forms or methods disclosed, but to the contrary, the disclosure is to cover all modifications, equivalents, and alternatives. In particular, it is contemplated that functional implementation of the disclosed embodiments described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of the disclosed embodiments not be limited by this detailed description, but rather by the claims following.

What is claimed is:

1. A method for confirming digital content, comprising:
selecting information evidencing misappropriation of a selected intellectual property right in the digital content;
utilizing said information to search for potential misappropriation of the intellectual property right;
applying the potential misappropriation to identify a possible misuse of the intellectual property right;
verifying the possible misuse to provide a verified misuse of the intellectual property right; and
categorizing the verified misuse.

2. The method of claim 1, further comprising:
storing said verified misuse.

3. The method of claim 2, wherein said storage of said verified misuse comprises descriptive data of said verified misuse.

4. The method of claim 1, wherein said verifying includes physically verifying the possible misuse.

5. The method of claim 1, wherein said verifying includes utilizing digital fingerprinting for verifying the possible misuse.

6. The method of claim 1, wherein said verifying includes utilizing watermarking for verifying the possible misuse.

7. The method of claim 2, further comprising:
delivering said verified misuse to a data reporting system.

8. The method of claim 7, wherein the data reporting system can send a notice to an appropriate party, wherein the appropriate party is determined by connection to said verified misuse.

9. The method of claim 3, wherein said descriptive data can be communicated to said application of the potential misappropriation to prevent redundant verification.

10. A method for confirming intellectual property rights in digital content, comprising:
selecting information evidencing misappropriation of a selected intellectual property right;
searching for predetermined digital content associated with the intellectual property right;
applying the selected information to identify the predetermined digital content;
verifying that the predetermined digital content comprises a verified misuse of the intellectual property right; and
categorizing the verified misuse,
wherein said confirming assists said searching for predetermined digital content that comprises a verified misuse of an intellectual property right.

11. The method of claim 10, further comprising:
storing said verified misuse.

12. The method of claim 11, wherein said storage of said verified misuse comprises descriptive data of said verified misuse.

13. The method of claim 10, wherein said verifying includes physically verifying the possible misuse.

14. The method of claim 10, wherein said verifying includes utilizing digital fingerprinting for verifying the possible misuse.

15. The method of claim 10, wherein said verifying includes utilizing watermarking for verifying the possible misuse.

16. The method of claim 11, further comprising:
delivering said verified misuse to a data reporting system.

17. The method of claim 16, wherein the data reporting system can send a notice to an appropriate party, wherein the appropriate party is determined by connection to said verified misuse.

18. The method of claim 12, wherein said descriptive data can be communicated to said application of the selected information to prevent redundant verification.

19. A computer system comprising:
A processor; and
A memory, the memory including one or more modules, the one or more modules collectively or individually comprising instructions for:
selecting information evidencing misappropriation of a selected intellectual property right in the digital content;
utilizing said information to search for potential misappropriation of the intellectual property right;
applying the potential misappropriation to identify a possible misuse of the intellectual property right;
verifying the possible misuse to provide a verified misuse of the intellectual property right; and
categorizing the verified misuse.

20. The computer system of claim 19, said instructions further comprising:
storing said verified misuse.

21. The computer system of claim 20, wherein said storage of said verified misuse comprises descriptive data of said verified misuse.

22. The computer system of claim 19, wherein said verifying includes physically verifying the possible misuse.

23. The computer system of claim 19, wherein said verifying includes utilizing digital fingerprinting for verifying the possible misuse.

24. The computer system of claim 19, wherein said verifying includes utilizing watermarking for verifying the possible misuse.

25. The computer system of claim 20, said instructions further comprising:
delivering said verified misuse to a data reporting system.

26. The computer system of claim 25, wherein the data reporting system can send a notice to an appropriate party, wherein the appropriate party is determined by connection to said verified misuse.

27. The computer system of claim 21, wherein said descriptive data can be communicated to said application of the potential misappropriation to prevent redundant verification.
